(19) United States
(12) Patent Application Publication
(10) Pub. No.: US 2013/0013895 A1
(43) Pub. Date: Jan. 10, 2013

(54) BYTE-ORIENTED MICROCONTROLLER HAVING WIDER PROGRAM MEMORY BUS SUPPORTING MACRO INSTRUCTION EXECUTION, ACCESSING RETURN ADDRESS IN ONE CLOCK CYCLE, STORAGE ACCESSING OPERATION VIA POINTER COMBINATION, AND INCREASED POINTER ADJUSTMENT AMOUNT

(75) Inventor: Hsiao-Ming Huang, Kao-Hsiung City (TW)

(73) Assignee: FS-SEMI CO., LTD., Hsinchu (TW)

(21) Appl. No.: 13/176,760

(22) Filed: Jul. 6, 2011

(51) Int. Cl. G06F 9/30; G06F 9/302

(52) U.S. Cl. 712/205; 712/221; 712/E09.016; 712/E09.017

(57) ABSTRACT

An exemplary byte-oriented microcontroller includes a program memory, a program memory bus, and a core circuit. The program memory bus has a bus width wider than one instruction byte, and the core circuit is coupled to the program memory through the program memory bus for executing at least one instruction by processing a plurality of instruction bytes fetched from the program memory. The core circuit includes a fetch unit, for fetching the instruction bytes through the program memory bus and re-ordering the fetched instruction bytes to form a complete instruction.

### BACKGROUND OF THE INVENTION

1. Field of the Invention

The disclosed embodiments of the present invention relate to a microcontroller, and more particularly, to a byte-oriented microcontroller capable of achieving instruction execution in one clock cycle and having extended data pointers.

2. Description of the Prior Art

In a conventional byte-oriented microcontroller, a length of an instruction may be longer than a bus width of a program memory, which wastes clock cycles when pipeline architecture is employed in the microcontroller. For an illustrated example of this, please refer to FIG. 1, which shows the instruction execution of a conventional pipelined 8051-based microcontroller. As shown in FIG. 1, there are four instructions (instructions A, B, C, and D) with instruction lengths ranging from one byte to three bytes. As the bus width of the program memory of the microcontroller is 8 bits wide, the instruction execution cannot be completed before all instruction bytes are successfully fetched. Taking the instruction A as an example, when the program memory address 0 corresponding to an operational code (opcode) of instruction A is ready, the corresponding 8-bit program memory data (represented as program memory code [7:0]) is fetched through the 8-bit wide program memory, and the execution of instruction A is not completed until the third byte of instruction A is successfully fetched. Therefore, it is demonstrated that only a one-byte instruction can achieve one-cycle performance. When an instruction with more than one byte is to be executed, many clock cycles are wasted. In addition, more than one clock cycle is needed for the execution of “call” and “return” instructions due to accessing a return address which is wider than a bus width of a data memory, and this also degrades the instruction execution performance. As a person skilled in the art can readily understand operations in ordinary pipeline stages, such as fetch, decode, execution, etc., further description is omitted here for brevity.

Moreover, due to the progress of semiconductor process technology, data memory size may be far beyond an access space of a conventional data pointer used in the conventional microcontroller.

Thus, there is a need for an innovative byte-oriented microcontroller design with improved instruction execution performance.

### SUMMARY OF THE INVENTION

In accordance with exemplary embodiments of the present invention, an innovative architecture of a byte-oriented microcontroller is proposed to solve the above-mentioned problems.

According to a first aspect of the present invention, an exemplary byte-oriented microcontroller is disclosed. The exemplary byte-oriented microcontroller includes a program memory, a program memory bus, and a core circuit. The program memory bus has a bus width wider than one instruction byte, and the core circuit is coupled to the program memory through the program memory bus for executing at least one instruction by processing a plurality of instruction bytes fetched from the program memory. The core circuit includes a fetch unit, for fetching the instruction bytes through the program memory bus and re-ordering the fetched instruction bytes to form a complete instruction. The core circuit further executes a plurality of instructions by processing the fetched instruction bytes, the byte-oriented microcontroller further includes a data memory, and the core circuit includes an arithmetic logic unit, a register unit, a decode unit, and a memory control unit. The decode unit is for decoding the fetched instruction bytes to generate a decoded result. The memory control unit is coupled to the decode unit, the arithmetic logic unit, the register unit, and the data memory, for preparing addresses and data of source/destination operands of the fetched instruction bytes and arranges a plurality of data paths between the arithmetic logic unit, the register unit, and the data memory according to the decoded result.

According to a second aspect of the present invention, an exemplary byte-oriented microcontroller is disclosed. The exemplary byte-oriented microcontroller includes a random access memory and a random access memory interface. The random access memory is for buffering a return address, and the random access memory interface is coupled to the random access memory for accessing the return address, wherein the random access memory interface has a bus width wider than one instruction byte.

According to a third aspect of the present invention, an exemplary byte-oriented microcontroller is disclosed. The exemplary byte-oriented microcontroller includes a first register unit, a second register unit, and an arithmetic logic unit. The first register unit is for providing a first pointer, the second register unit is for providing a second pointer, and the arithmetic logic unit is coupled to the first register unit and the second register unit for performing an indirect access to a memory address space by combining the first pointer and the second pointer.

According to a fourth aspect of the present invention, an exemplary byte-oriented microcontroller is disclosed. The exemplary byte-oriented microcontroller includes a register unit and an arithmetic logic unit. The register unit is for providing a pointer having more than 8 bits, and the arithmetic logic unit is coupled to the register unit for increasing or decreasing the pointer by an adjustment amount in one arithmetic instruction.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating instruction execution of a conventional pipelined 8051-based microcontroller.

FIG. 2 is a block diagram illustrating a first exemplary byte-oriented microcontroller according to the present invention.

FIG. 3A is a block diagram illustrating a second exemplary byte-oriented microcontroller according to the present invention.

FIG. 3B is a diagram illustrating an exemplary instruction execution performed by the byte-oriented microcontroller shown in FIG. 3A to execute the instructions shown in FIG. 1.

FIG. 4A is a diagram illustrating an exemplary division of a memory space of the program memory shown in FIG. 3A.

FIG. 4B is a diagram illustrating the arrangements for the fetched bytes based on the exemplary memory space division shown in FIG. 4A.

FIG. 4C is a diagram illustrating an example of a short program stored in program memory and a fetching sequence.

FIG. 5A is a diagram illustrating an example of the execution of three instructions in the ordinary pipelined 8051-based microcontroller

FIG. 5B is a block diagram illustrating a third exemplary byte-oriented microcontroller according to the present invention.

FIG. 5C is a diagram illustrating an exemplary combination of data paths according to the instruction execution shown in FIG. 5A.

FIG. 6A is a diagram illustrating exemplary data paths for 8051 instructions in the exemplary byte-oriented microcontroller shown in FIG. 5B.

FIG. 6B is a diagram illustrating exemplary data paths of combinations for existing 8051 instructions in the exemplary byte-oriented microcontroller shown in FIG. 5B.

FIG. 7 is a block diagram illustrating a fourth exemplary byte-oriented microcontroller according to the present invention.

FIG. 8 is a block diagram illustrating a fifth exemplary byte-oriented microcontroller according to the present invention.

FIG. 9 is a block diagram illustrating a sixth exemplary byte-oriented microcontroller according to the present invention.

FIG. 10 is a block diagram illustrating a seventh exemplary byte-oriented microcontroller according to the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

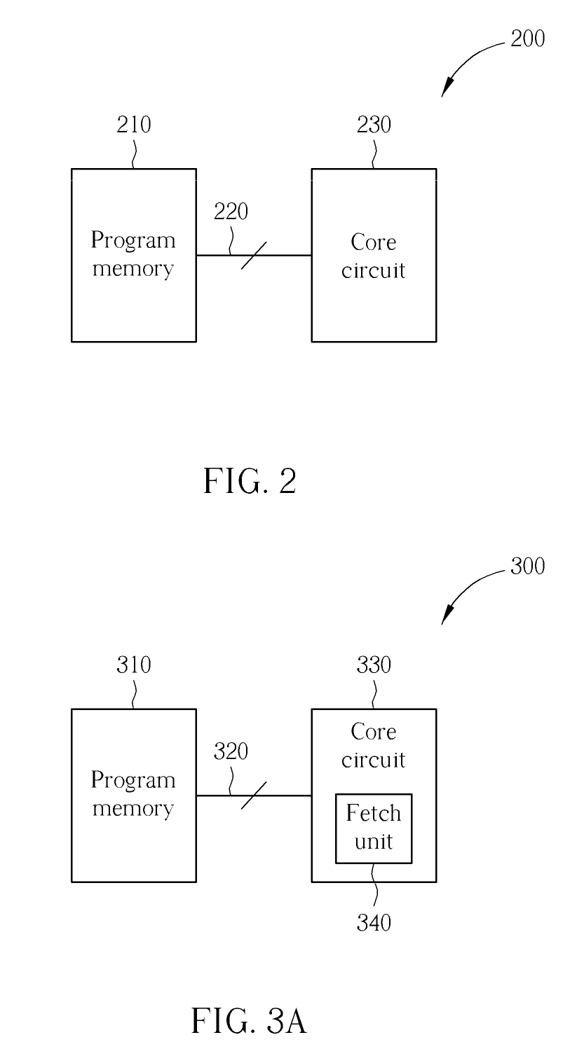

Please refer to FIG. 2, which is a block diagram illustrating a first exemplary byte-oriented microcontroller according to the present invention. The exemplary byte-oriented microcontroller (e.g. an 8051-based microprocessor) 200 includes, but is not limited to, a program memory 210, a program memory bus 220, and a core circuit 230. The program memory bus 220 has a bus width wider than one instruction byte, and the core circuit 230 is coupled to the program memory through the program memory bus 220 for instruction execution. For example, the core circuit 230 may execute at least one instruction by processing a plurality of instruction bytes fetched from the program memory 210 via the program memory bus 220. As shown in FIG. 2, the extended bus width of the program memory bus allows more instruction bytes to be fetched in one clock cycle, thereby reducing the clock cycles needed for fetching all of the desired instruction bytes when an instruction with more than one byte is executed. Compared to the conventional byte-oriented microcontroller (e.g. a conventional pipelined 8051-based microprocessor), the exemplary byte-oriented microcontroller 200 of the present invention has better instruction execution performance due to the use of a program memory bus with a wider bus bandwidth.

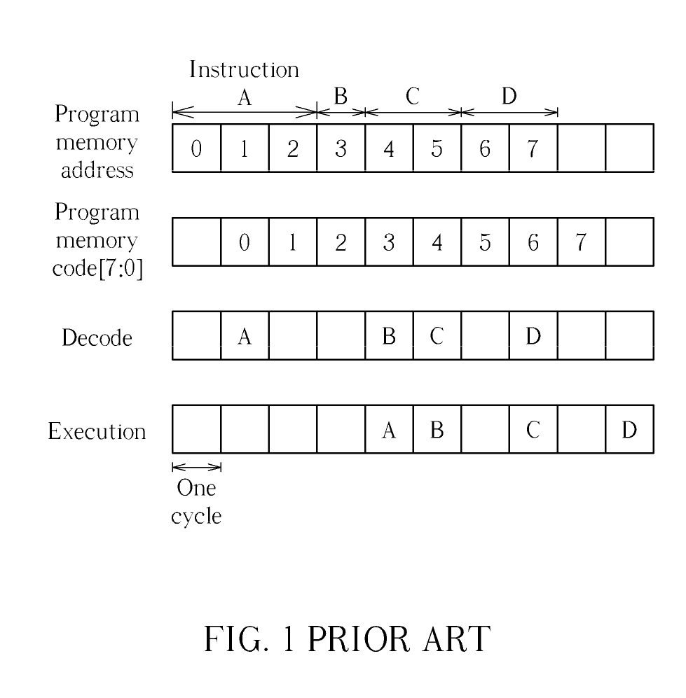

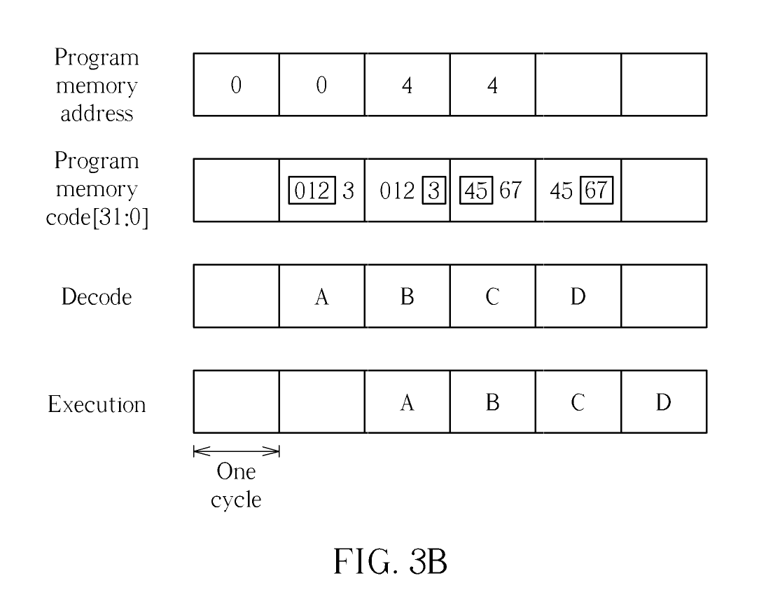

Please refer to FIG. 3A, which is a block diagram illustrating a second exemplary byte-oriented microcontroller according to the present invention. The exemplary byte-oriented microcontroller 300 is an 8051-compatible microcontroller utilizing the concept shown in FIG. 2 to solve the instruction execution degradation problem encountered by the conventional microcontroller. The exemplary byte-oriented microcontroller 300 includes, but is not limited to, a program memory 310, a program memory bus 320, and a core circuit 330. In this exemplary embodiment, a bus width of the program memory bus 320 is 32 bits, which is not smaller than a maximum value of instruction lengths of an 8051 instruction supported by the core circuit 330. The core circuit 330 is coupled to the program memory through the program memory bus 320, and capable of executing at least one instruction by processing a plurality of instruction bytes fetched from the program memory 310. Please refer to FIG. 3B in conjunction with FIG. 1. FIG. 3B illustrates an exemplary instruction execution performed by the byte-oriented microcontroller 300 shown in FIG. 3A to execute the instructions A-D shown in FIG. 1. As can be seen in this example, the corresponding program memory data are fetched through the 32-bit program memory bus 320, and can be represented by program memory code [31:0]. It should be noted that all instruction bytes of an instruction are fetched in the same cycle (i.e., a single cycle). In this exemplary embodiment, all instruction bytes of two instructions A and B are fetched in one cycle, and all instruction bytes of two instructions C and D are fetched in another cycle. Thus, the enclosed symbols “ [symbol] 3”, “012 [symbol] ”, “ [symbol] 67”, and “45 [symbol] ” mean that instruction bytes of the instructions A-D are under processing in certain clock cycles. Specifically, the first three bytes of the first 32-bit instruction data belong to the instruction A, the remaining one byte of the first 32-bit instruction data belongs to the instruction B, the first two bytes of the second 32-bit instruction data belong to the instruction C, and the remaining two byte of the second 32-bit instruction data belong to the instruction D. In other words, all instructions A-D can achieve one-cycle performance. It should be noted that, as more than one instruction byte is fetched in one cycle, the fetched instruction bytes may need to be re-ordered to form a complete instruction. Therefore, in an example in this embodiment, the core circuit 330 may include a fetch unit 340 to meet the above requirement. The implementation of re-ordering fetched instruction bytes is detailed as follows.

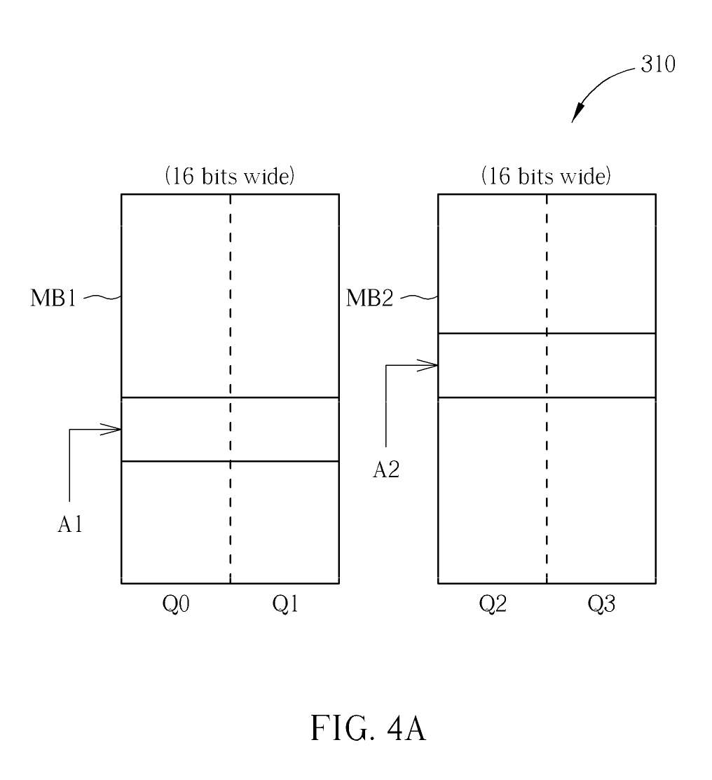

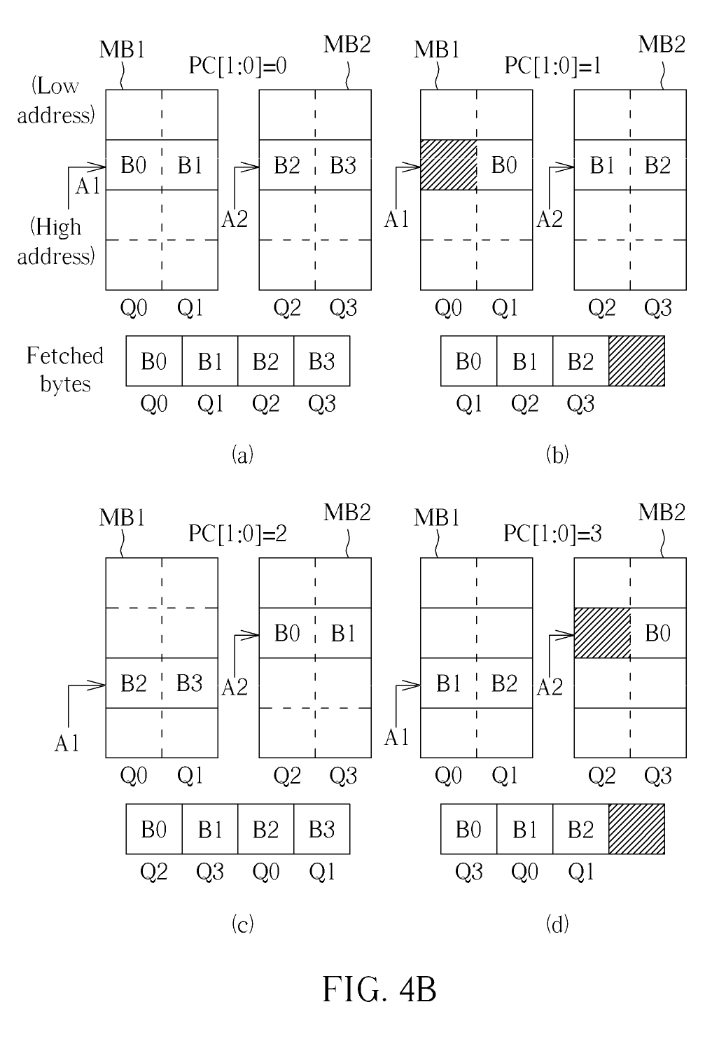

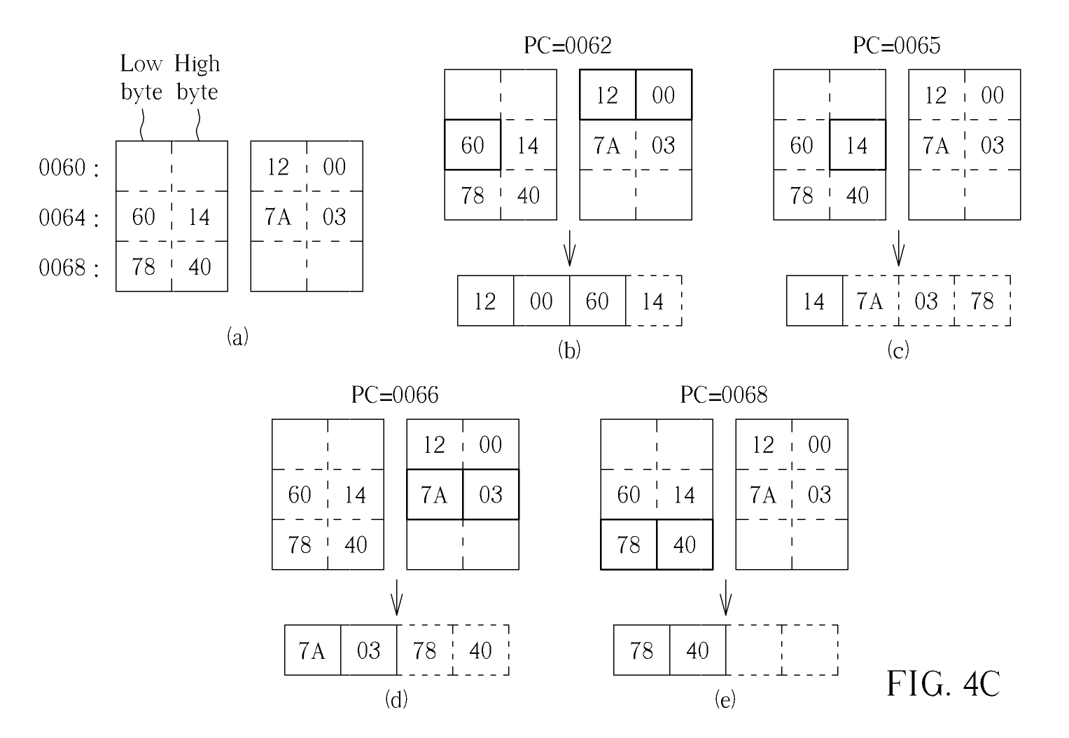

Since a starting address of an instruction in byte-oriented microcontroller 300 may not be aligned with the 32-bit wide program memory bus 320, there might be some problems in having all instructions fetched in one cycle. When fetching a three-byte instruction, the first byte of the three-byte instruction may be accessed at a time point different from a time point at which the last byte of the three-byte instruction is accessed. One method to solve the above problem is to divide a memory space of a program memory into a plurality of memory blocks, for example, two memory blocks, and then to rearrange the instruction bytes according to a program counter. Please refer to FIG. 4A, which illustrates an exemplary division of a memory space of the program memory 310 shown in FIG. 3A. In this embodiment, the memory space of the program memory 310 is divided into a first memory block MB1 which is 16 bits wide and a second memory block MB2 which is 16 bits wide, where a first fetch address input A1 is dedicated to the first memory block MB1, a second fetch address input A2 is dedicated to the second memory block MB2, and the above-mentioned two memory blocks MB1 and MB2 are read for fetching instruction data simultaneously. The first memory block MB1 includes a first output port consisting of banks Q0 and Q1, each being 8 bits wide, and the second memory block MB2 includes a second output port consisting of banks Q2 and Q3, each being 8 bits wide. Therefore, all instruction bytes can be retrieved and rearranged according to the first fetch address input A1 and second fetch address input A2 both provided by a program counter (PC) (not shown). Please refer to FIG. 4B for further illustration.

FIG. 4B illustrates the arrangements for the fetched bytes based on the exemplary division of the memory space shown in FIG. 4A. As shown in FIG. 4B, low fetched addresses are situated at upper locations in each bank of the program memory 310, instruction bytes B0-B3 represent the fetched instruction bytes with low address to high address, and the program counter here is 16 bits wide. This is for illustrative purposes only, and is not meant to be a limitation of the present invention. In addition, as the first byte (e.g., instruction byte B0) may come from bank Q0, Q1, Q2, or Q3, the re-ordering is required to form the correct instruction bytes.

There are four possible arrangements of instruction bytes in the program memory 310 according to the two least significant bits (LSBs) of the program counter (i.e. PC [1:0]), as shown in sub-diagrams (a)-(d) in FIG. 4B. The two LSBs of the PC are equal to 0, 1, 2, and 3, respectively. It is notable that, because instruction bytes in the first memory block MB1 and the second memory block MB2 may be located at different word addresses (i.e. instruction bytes B0 and B1 are located at word addresses different from those at which the instruction bytes B2 and B3 in sub-diagram (c) are located), the fetch unit 340 will provide fetch addresses for the first memory block MB1 and the second memory block MB2, individually. That is, as shown in sub-diagram (c) in FIG. 4B, the first fetch address input A1 and second fetch address input A2 provided by a program counter may be different. For example, suppose the program counter PC is 16 bits wide, the first fetch address input A1 and the second fetch address input A2 are 14 bits wide, and the second fetch address input A2 is represented as PC[15:2]. The first fetch address input A1 may be equal to PC[15:2] when PC[1] is 0, and A1 may be equal to PC[15:2]+1 when PC[1] is 1. In this way, the instruction bytes are re-ordered according to the program counter, and the fetched bytes may start at the bank Q0, Q1, Q2, or Q3

Please refer to FIG. 4C, which illustrates an example of a short program stored in the program memory 310 shown in FIG. 3A and its fetching sequence. The codes for the short program, including machine language and assembly language, are as follows.

| | |
|---|---|
| 0062: 12 00 60 | LCALL 0060h |
| 0065: 14 | DEC A |
| 0066: 7A 03 | MOV R2, #03h |
| 0068: 78 40 | MOV R0, #40h |

As a person skilled in the art can readily understand the meaning of the above program codes, only the fetching sequence is illustrated here for brevity. The relation between fetch addresses and instruction bytes is shown in sub-diagram (a) in FIG. 4C, where a left byte is a low byte compared to a right byte in each memory bank, and the resulting fetched bytes corresponding to two different LSBs of the program counter are shown in sub-diagram (b)-(e) in FIG. 4C. As shown in sub-diagram (b) in FIG. 4C, when the program counter (PC) equals 0062, the instruction bytes 12 and 00 in memory block MB2 and the instruction bytes 60 and 14 in memory block MB1 are read simultaneously. Because the two LSBs of the program counter equal 2, the fetched bytes are 12, 00, 60, and 14, while fetched byte 14 is not executed until the PC equals 0065. Based on the above illustration, fetched bytes corresponding to the different instructions can be known, as shown in sub-diagram (c)-(e) in FIG. 4C.

It should be noted that the above-mentioned example is for illustrative purposes only, and is not meant to be a limitation of the present invention. According to a variation of this embodiment, the bus width of the program memory bus 220 may be wider than or equal to a maximum value of the instruction lengths of instructions supported by the core circuit 330, which leads to a result that all the instruction bytes of at least one instruction are fetched by the core circuit 330 in one cycle. According to another variation of this embodiment, the memory space of the program memory 310 may be divided into more than two blocks, and the number of fetch address inputs can also be adjusted, depending upon actual design requirements/consideration.

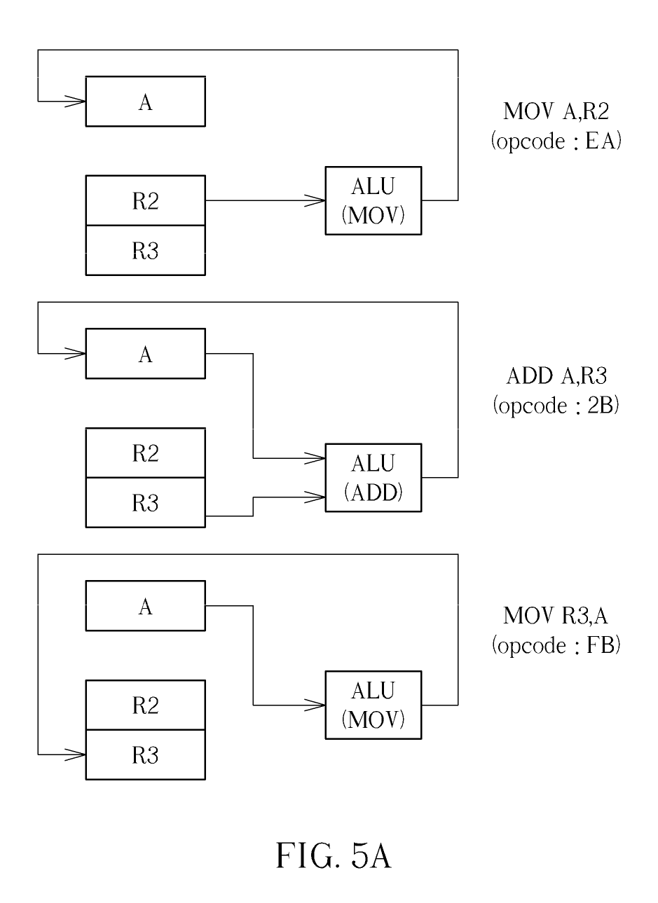

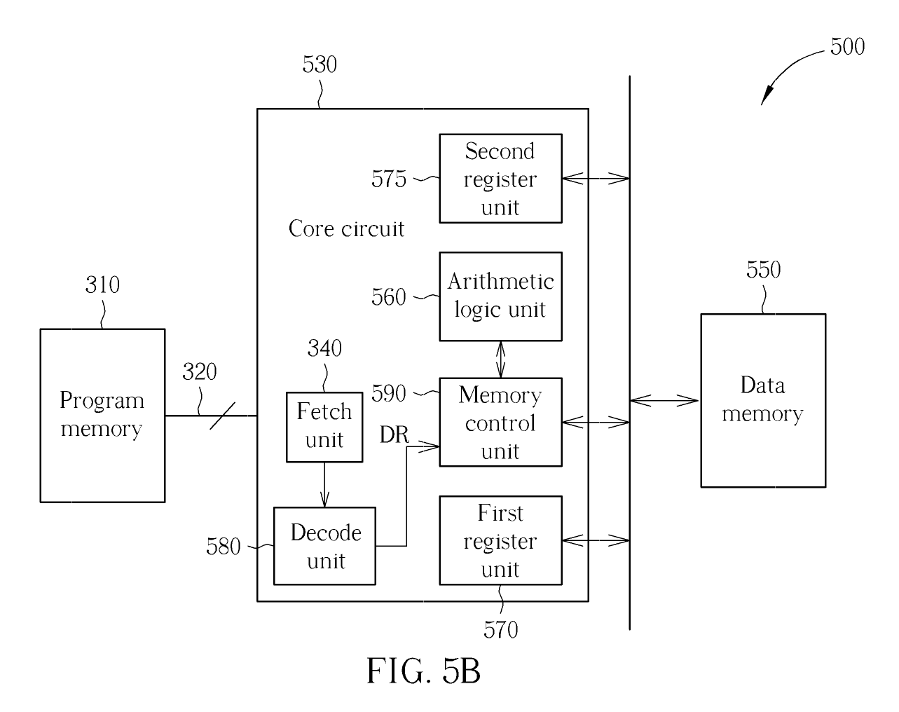

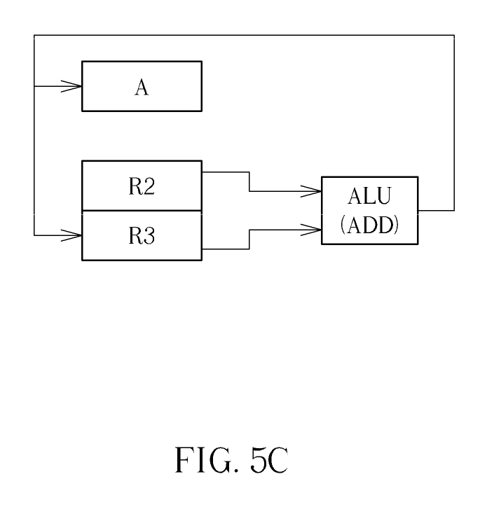

Because at least one instruction with more than one instruction byte can be fetched in one clock cycle in this embodiment, more than one instruction may be executed in one cycle in some situations. Please refer to FIG. 5A, which illustrates an example of the execution of three instructions in the ordinary pipelined 8051-based microcontroller. The three instructions are as follows.

MOV A, R2

ADD A, R3

MOV R3, A

where A represents an accumulator (a register in a conventional 8051-based microcontroller), and R2 and R3 are registers. As shown in FIG. 5A, opcodes corresponding to the three instructions are EA, 2B, and FB, respectively, and the arrow symbols represent data paths. For example, an arrow symbol between register R2 and an arithmetic unit (ALU) performing instruction MOV represents passing data in register R2 to ALU. Also, the three instructions will be executed sequentially and take many clock cycles. In accordance with the instruction definitions in the conventional 8051-based microcontroller, the execution result of the three instructions is equivalent to: R3←A←R2+R3. Therefore, if an opcode pattern of the three instructions (i.e. EA 2B FB) can be identified, the three instructions can be performed in one cycle with the help of well arranged data paths. As a person skilled in the art can readily understand execution of the three instructions in pipeline stages of the conventional 8051-based microcontroller, further description is omitted here for brevity.

Please refer to FIG. 5B, which is a block diagram illustrating a third exemplary byte-oriented microcontroller according to the present invention. The architecture of the exemplary byte-oriented microcontroller 500 is mainly based on (but is not limited to) the byte-oriented microcontroller 300 shown in FIG. 3A. Therefore, the exemplary byte-oriented microcontroller 500 includes, but is not limited to, a program memory 310, a program memory bus 320, a core circuit 530, and a data memory 550. The core circuit 530 is coupled to the program memory 310 through the program memory bus 320, and is capable of executing a plurality of instruction by processing a plurality of instruction bytes fetched from the program memory 310. In this exemplary embodiment, the core circuit 530 includes a fetch unit 340, an arithmetic logic unit 560, a first register unit 570, a second register unit 575, a decode unit 580, and a memory control unit 590. The decode unit 580 is for decoding the fetched instruction bytes to generate a decoded result DR. The memory control unit 590 is coupled to the decode unit DR, the arithmetic logic unit 560, the first register unit 570, the second register unit 575, and the data memory 550, and implemented for preparing addresses and data of source/destination operands of the fetched instruction bytes and arranging a plurality of data paths between the arithmetic logic unit 560, the first register unit 570, the second register unit 575, and the data memory 550 according to the decoded result DR.

Please refer to FIG. 5B in conjunction with FIG. 5C. FIG. 5C illustrates an exemplary combination of data paths according to the instruction execution shown in FIG. 5A. When the decode unit 580 decodes fetched instruction bytes and then detects the opcode pattern (i.e. EA 2B FB) after the three instructions are fetched and re-ordered in the fetch unit 340, the memory control unit 590 is operative to prepare addresses and data of source/destination operands of the fetched instruction bytes, and arrange data paths between the register R2 (in the first register unit 570), the register R3 (in the first register unit 570), the arithmetic logic unit (ALU) 560, and the accumulator A (in the second register unit 575). As the three instructions are one-byte instructions, all the fetched instruction bytes can be executed in one clock cycle. In addition, the three instructions can be treated as a macro instruction “RADDR R3, R2, R3”, and the first register unit 570 may have two read ports and two write ports for facilitating arrangement of the data paths.

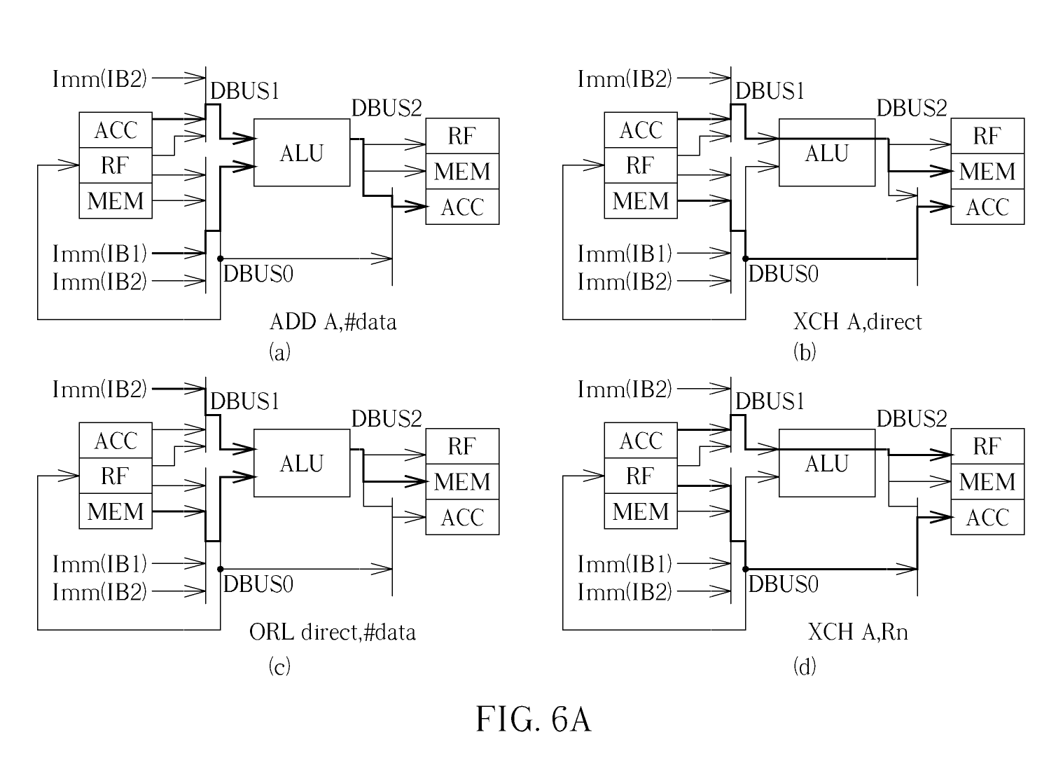

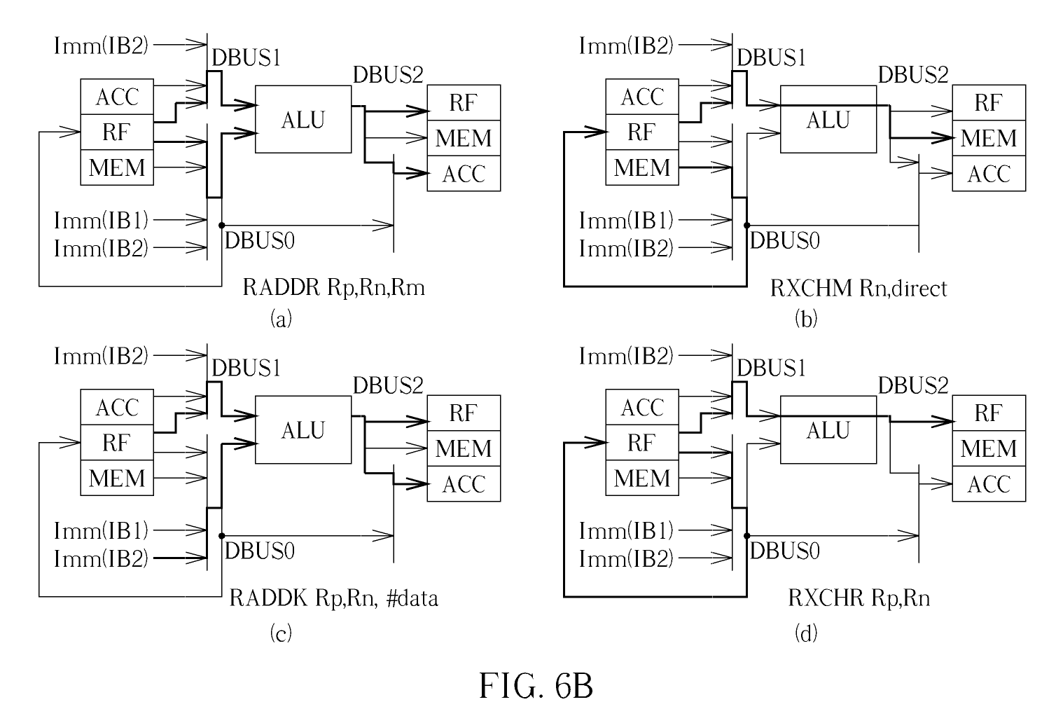

Please refer to FIG. 6A, which illustrates exemplary data paths for 8051-based instructions in exemplary byte-oriented microcontroller 500. There are 3 major data buses in this embodiment: a first data bus DBUS0, a second data bus DBUS1, and a third data bus DBUS2, where the first data bus DBUS0 and the second data bus DBUS1 are inputs of the arithmetic logic unit 560, and the third data bus DBUS2 is the output of the arithmetic logic unit 560. The first data bus DBUS0 and the second data bus DBUS1 are from various source operands, which are well arranged by the memory control unit 590 according to possible combinations of operands of 8051-based instructions. The arrangement of data paths may reduce a size of a multiplexer (not shown), and the first data bus DBUS0 can also be the input of the first register unit 570 and the second register unit 575 for macro instruction execution. Taking the instruction “ADD A, #data” for example, source operand types are decoded from instruction, and the source operand types determine the selection of the multiplexer of the first data bus DBUS0 and the second data bus DBUS1. In this case, the accumulator (ACC) in the second register unit 575 is selected for the second data bus DBUS1, and an immediate value Imm(IB1) from the second byte of the instruction is selected for the first data bus DBUS0. The “ADD” function of the arithmetic logic unit 560 for this instruction is controlled by instruction type. The output of the arithmetic logic unit 560 will be put on the third data bus DBUS2, which will be written back to ACC. In addition, as shown in FIG. 6A, an immediate value from the third byte of the instruction is represented as Imm(IB2), the data memory 550 is represented as MEM, and RF represents the registers in the first register unit 570. As a person skilled in the art can readily understand operations of other instructions shown in FIG. 6A, such as “XCH A, direct”, “ORL direct, #data”, and “XCH A, Rn”, further description is omitted here for brevity.

Please refer to FIG. 6B, which illustrates exemplary data paths of combinations for 8051 instructions (i.e., macro instructions) in the exemplary byte-oriented microcontroller 500. The corresponding 8051-based instructions for the four macro instructions are also shown in FIG. 6B. Please note that the macro instructions are not limited to the four cases shown in FIG. 6B. Taking a macro instruction “RXCHR Rp, Rn” for example, the macro instruction consists of three 8051-based instructions:

XCH A, Rp

XCH A, Rn

XCH A, Rp

The execution result of the above three instructions is equivalent to “exchange Rp and Rn”. Since there are 2 read ports and 2 write ports supported by the first register unit 570, the macro instruction can be done in one clock cycle. Data of one selected register will be output to the second data bus DBUS1, through the arithmetic logic unit 560 to the third data bus DBUS2, and then be written to the first register unit 570. Data of the other selected register will be output to the first data bus DBUS0 and fed back to another write port of the first register unit 570. As a person skilled in the art can readily understand operations in other macro instructions shown in FIG. 6B according to the paragraph mentioned above, further description is omitted here for brevity.

It should be noted that the above-mentioned instructions are for illustrative purposes only, and are not meant to be a limitation of the present invention. That is, any byte-oriented microcontrollers utilizing the combinations of instructions and arrangement of data paths to execute the instructions within fewer clock cycles obey the spirit of the present invention.

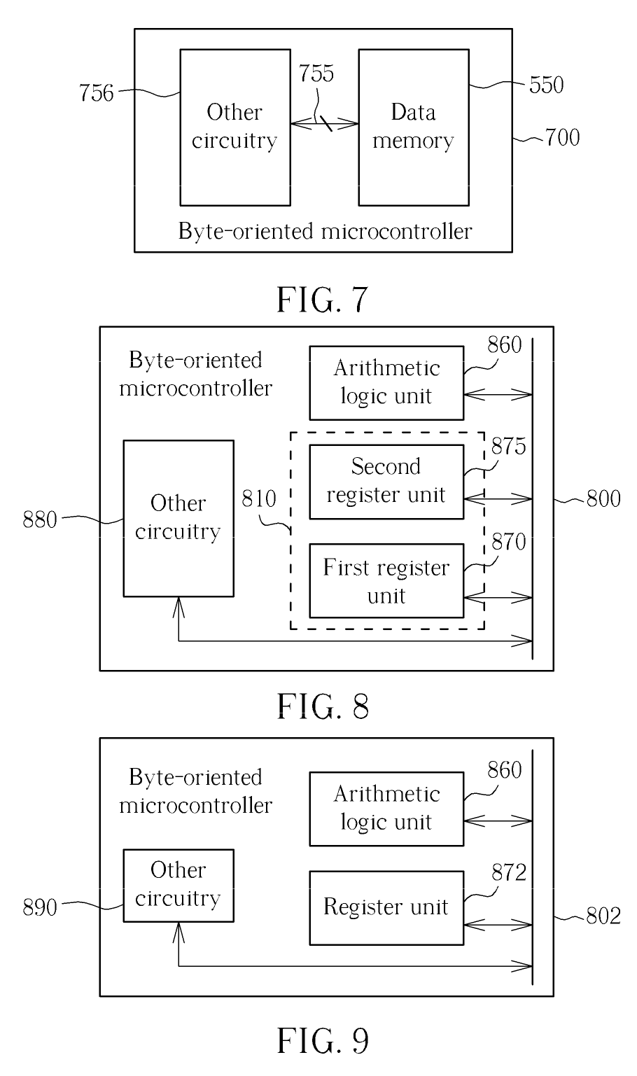

In a conventional 8051-based microcontroller, the executions of instructions “call” and “return” are performed in more than one clock cycle because a return address pushed to/popped from a stack is 16 bits wide, while a data memory is one-byte wide. Please refer to FIG. 7, which is a block diagram illustrating a fourth exemplary byte-oriented microcontroller according to the present invention. The exemplary byte-oriented microcontroller 700 includes, but is not limited to, a data memory 550, a data memory interface 755, and other circuitry 756. The other circuitry 756 may include circuit elements needed for performing the designated functionality of the byte-oriented microcontroller 700. The data memory 550 is for buffering a return address, and the data memory interface 755, coupled to the data memory 550, is for accessing the return address. Please note that the data memory interface 755 has a bus width wider than one instruction byte. By way of example, but not limitation, the data memory interface 755 may have a 16-bit bus width to access the return address in one clock cycle.

In order to extend the indirect access to the address space, an exemplary byte-oriented microcontroller is disclosed. Please refer to FIG. 8, which is a block diagram illustrating a fifth exemplary byte-oriented microcontroller according to the present invention. The exemplary byte-oriented microcontroller 800 includes, but is not limited to, a register block 810 including a first register unit 870 and a second register unit 875, an arithmetic logic unit 860, and other circuitry 880. The other circuitry 880 may include circuit elements needed for performing the designated functionality of the byte-oriented microcontroller 800. The first register unit 870 is for providing a first pointer, the second register unit 875 is for providing a second pointer, and the arithmetic logic unit 860, coupled to the first register unit 870 and the second register unit 875, is for performing an indirect access to a memory address space by combining the first pointer and the second pointer. By way of example, the first register unit 870 provides an 8-bit pointer R0 to access a 256-byte address range. In a case where it is needed to access a memory address beyond the address range addressed by the pointer R0, the pointer R0 will act as a signed offset address, and a 16-bit pointer R0X provided by the second register unit 875 will act as a base address to be added to the pointer R0 by the arithmetic logic unit 860. In other words, the pointer R0X (e.g., the base address) may be set to point to a certain memory block, and then the address to be accessed will be determined according to the pointer R0 (e.g., the signed offset address). In this embodiment, the indirect address will be in the range of “the base address −128” to “the base address +127”. For example, if the address pointed by pointer R0X is 02DEh and the address pointed by pointer R0 is 68h, the indirect address will be 0346h. According to a variation of this embodiment, the pointer R0 may act as an offset address rather than a signed offset address. For example, the indirect address will be in the range of “the base address” to “the base address +255”. In addition, in an alternative design, the pointer R0X may include a high byte R0XH and a low byte R0XL, and the high byte R0XH may be combined with register R0 to point to another memory space.

According to another variation of this embodiment, the arithmetic logic unit 860 performs the indirect access by summing up a first pointer provided by the first register unit 870 and a second pointer provided by the second register unit 875, where either the first pointer or the second pointer is not limited to a base address or an offset address. In addition, the above concept may be utilized in extending a stack pointer. In another alternative design, the arithmetic logic unit 860 performs the stack accessing operation according to a stack pointer having a first part and a second part respectively set by the first pointer and the second pointer. For example, a 16-bit stack pointer SPX may be extended by consisting of a high byte (e.g., a first 8-bit pointer SPH) and a low byte (e.g., a second 8-bit pointer SP). It should be noted that the above-mentioned example is for illustrative purposes only, and is not meant to be a limitation of the present invention. That is, any byte-oriented microcontroller utilizing combination of data pointers or addition of a base address and an offset address to extend the address range obeys the spirit of the present invention.

An exemplary byte-oriented microcontroller is disclosed for the increment and decrement of the above extended data pointers. Please refer to FIG. 9, which is a block diagram illustrating a sixth exemplary byte-oriented microcontroller according to the present invention. The exemplary byte-oriented microcontroller 802 includes, but is not limited to, a register unit 872, an arithmetic logic unit 860, and other circuitry 890. The other circuitry 890 may include circuit elements needed for performing the designated functionality of the byte-oriented microcontroller 802. The register unit 872 is for providing a first pointer and a second pointer, and the arithmetic logic unit 860, coupled to the register unit 872, is for increasing or decreasing the first pointer by adding an adjustment amount (i.e., one adjustment step) assigned to the second pointer. Taking a conventional 8051-based microcontroller for example, the first pointer may be the 16-bit pointer R0X mentioned above, and the second pointer may be a write-only pointer R0XINC. When a value of 68h is written to R0XINC, the pointer R0X will be changed to 0346h if pointer R0X is 02DEh originally. It should be noted that the above-mentioned example is for illustrative purposes only, and is not meant to be a limitation of the present invention.

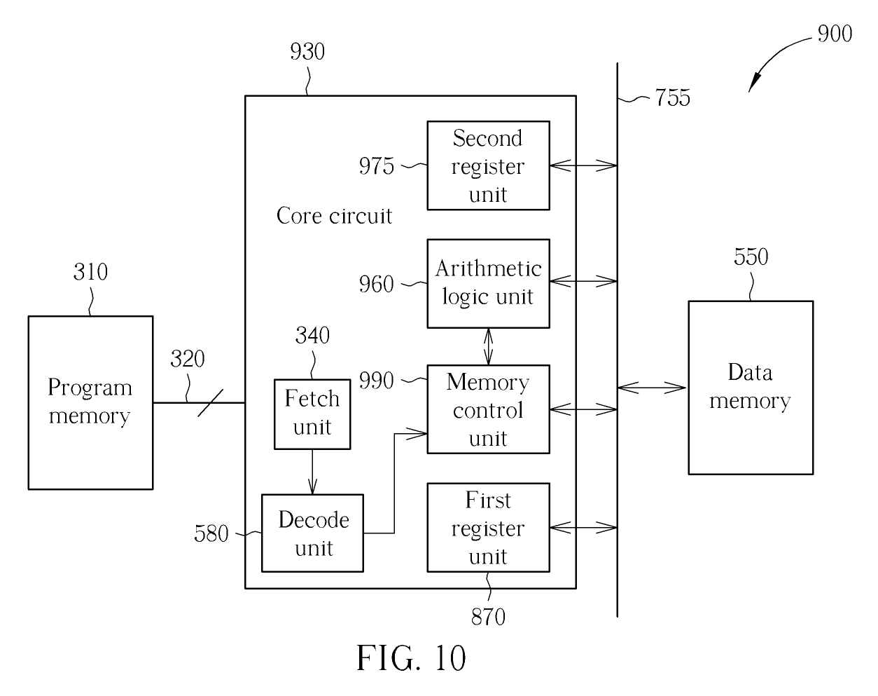

Please refer to FIG. 10, which is a block diagram illustrating a seventh exemplary byte-oriented microcontroller according to the present invention. The exemplary byte-oriented microcontroller (e.g., an 8051-based microcontroller) 900 is mainly based on architectures of the aforementioned byte-oriented microcontrollers 200, 300, 500, 700, 800, and 802. The byte-oriented microcontroller 900 includes, but is not limited to, a program memory 310, a program memory bus 320, a core circuit 930, a data memory 550, and a data memory interface 755. The core circuit 930 includes a fetch unit 340, a decode unit 580, a first register unit 970, a second register unit 975, a memory control unit 990, and an arithmetic logic unit 960. As the related operations and functions of the program memory 310, the program memory bus 320, the fetch unit 340, the decode unit 580, the data memory 550, and the data memory interface 755 are detailed above, further description is omitted here for brevity. The core circuit 930 is coupled to the program memory 310 through the program memory bus 320, and is also coupled to the data memory interface 755. The core circuit 930 executes at least one instruction by processing a plurality of instruction bytes fetched from the program memory 310, and further executes a plurality of instructions by processing the fetched instruction bytes. The memory control unit 990 prepares addresses and data of source/destination operands of the fetched instruction bytes and arranges a plurality of data paths between the arithmetic logic unit 960, the first register unit 970, the second register unit 975, and the data memory 550 according to the decoded result DR. The first register unit 970 provides a first pointer, the second register unit 975 provides a second pointer, and the arithmetic logic unit 960, coupled to the first register unit 970 and the second register unit 975, performs an indirect access to a memory address space by combining the first pointer and the second pointer. In addition, the second register unit 975 provides a third pointer and a fourth pointer, and the arithmetic logic unit 860 increases or decreases the third pointer by adding an adjustment amount assigned to the fourth pointer. Therefore, in addition to executing the above-mentioned operations and functions, the byte-oriented microcontroller 900 may further execute a plurality of integrated functions, such as macro instructions with extended data pointers or stack pointers, and/or other integrations of the functions in foregoing exemplary byte-oriented microcontrollers. Special function register (SFR) blocks (not shown) in the byte-oriented microcontrollers mentioned above may be utilized to enable the aforementioned functions (e.g. indirect addressing with extended data pointer) or the plurality of integrated functions.

Those skilled in the art will readily observe that numerous modifications and alterations of the device and method may be made while retaining the teachings of the invention.

What is claimed is:

1. A byte-oriented microcontroller, comprising:
a program memory;
a program memory bus, having a bus width wider than one instruction byte; and
a core circuit, coupled to the program memory through the program memory bus, for executing at least one instruction by processing a plurality of instruction bytes fetched from the program memory.

2. The byte-oriented microcontroller of claim 1, wherein the bus width of the program memory bus is wider than or equal to a maximum value of instruction lengths of instructions supported by the core circuit.

3. The byte-oriented microcontroller of claim 1, wherein the instruction bytes of the at least one instruction are fetched by the core circuit in one clock cycle.

4. The byte-oriented microcontroller of claim 1, wherein the core circuit comprises:
a fetch unit, for fetching the instruction bytes through the program memory bus and re-ordering the fetched instruction bytes to form a complete instruction.

5. The byte-oriented microcontroller of claim 4, wherein a memory space of the program memory is divided into a plurality of memory blocks; and the fetch unit provides a plurality of fetch addresses for fetching the instruction bytes stored in the memory blocks, and re-orders the fetched instruction bytes according to the fetch addresses.

6. The byte-oriented microcontroller of claim 4, wherein the core circuit executes a plurality of instructions by processing the fetched instruction bytes; the 8051-based microcontroller further comprises a data memory; and the core circuit comprises:
an arithmetic logic unit;
a first register unit;
a second register unit;
a decode unit, for decoding the fetched instruction bytes to generate a decoded result;
a memory control unit, coupled to the decode unit, the arithmetic logic unit, the first register unit, the second register unit, and the data memory, for preparing addresses and data of source/destination operands of the fetched instruction bytes and arranging a plurality of data paths between the arithmetic logic unit, the first register unit, the second register unit, and the data memory according to the decoded result.

7. The byte-oriented microcontroller of claim 6, wherein the fetched instructions are executed in one clock cycle.

8. The byte-oriented microcontroller of claim 6, wherein the first register unit has a plurality of read ports and a plurality of write ports.

9. A byte-oriented microcontroller, comprising:
a program memory;
a program memory bus; and
a core circuit, coupled to the program memory through the program memory bus, for executing at least one instruction by processing a plurality of instruction bytes fetched from the program memory, wherein the instruction bytes of the at least one instruction are fetched by the core circuit in one clock cycle.

10. The byte-oriented microcontroller of claim 9, wherein all instruction bytes of each instruction supported by the core circuit are fetched by the core circuit in one clock cycle.

11. The byte-oriented microcontroller of claim 9, wherein the fetched instruction bytes correspond to a plurality of instructions.

12. A byte-oriented microcontroller, comprising:
a data memory, for buffering a return address; and
a data memory interface, coupled to the data memory, for accessing the return address, wherein the data memory interface has a bus width wider than one instruction byte.

13. The byte-oriented microcontroller of claim 12, wherein the data memory interface accesses the return address in one clock cycle.

14. A byte-oriented microcontroller, comprising:
a data memory, for buffering a return address; and
a data memory interface, coupled to the data memory, for accessing the return address in one clock cycle.

15. A byte-oriented microcontroller, comprising:
a register block, for providing a first pointer and a second register unit; and
an arithmetic logic unit, coupled to the register block, for performing a storage accessing operation by combining the first pointer and the second pointer.

16. The byte-oriented microcontroller of claim 15, wherein the arithmetic logic unit performs an indirect access to a memory address space by combining the first pointer and the second pointer.

17. The byte-oriented microcontroller of claim 16, wherein the arithmetic logic unit adds the first pointer acting as a signed offset address to the second pointer acting as a base address for accessing a memory address beyond an address range addressed by the first pointer.

18. The byte-oriented microcontroller of claim 15, wherein the storage accessing operation is a stack accessing operation, and the arithmetic logic unit performs the stack accessing operation according to a stack pointer having a first part and a second part respectively set by the first pointer and the second pointer.

19. A byte-oriented microcontroller, comprising:
a register unit, for providing a first pointer having more than 8 bits; and
an arithmetic logic unit, coupled to the register unit, for increasing or decreasing the first pointer by an adjustment amount in one arithmetic instruction.

20. The byte-oriented microcontroller of claim 19, wherein the register unit further provides a second pointer having the adjustment amount assigned thereto.
